(19) United States
(12) Patent Application Publication
(10) Pub. No.: US 2007/0230537 A1
(43) Pub. Date: Oct. 4, 2007

(54) Weather instrument and method

(76) Inventor: Wendell V. Tangborn, Vashon Island, WA (US)

Correspondence Address: Kirkpatrick & Lockhart Preston Gates Ellis LLP;(FORMERLY KIRKPATRICK & LOCKHART NICHOLSON GRAHAM), STATE STREET FINANCIAL CENTER, One Lincoln Street, BOSTON, MA, 02111-2950, US

(21) Appl. No.: 11/732,144

(22) Filed: Apr. 2, 2007

Related U.S. Application Data
(60) Provisional application No. 60/744,102, filed on Mar. 31, 2006.

(51) Int. Cl. G01K 3/00

(52) U.S. Cl. 374/109

(57) ABSTRACT

A weather instrument and method for comparing current temperature at a location to historical temperatures at the location. In one embodiment, the weather instrument includes a temperature sensor producing a temperature signal; a clock producing a periodic time signal; a processor in communication with the temperature sensor and the clock, the processor producing hourly mean temperature measurements from the temperature sensor in response to the periodic time signal, and a memory in communication with the processor. The memory stores hourly mean temperature measurements and historical temperature data for the location. In one embodiment, the method includes the steps of producing hourly mean temperature measurements from a temperature sensor in response to said periodic time signal and storing said hourly mean temperature measurements and historical temperature data for said location in a memory.

### RELATED APPLICATIONS

This application claims priority to U.S. Provisional Patent Application 60/744,102 filed on Mar. 31, 2006, the disclosure of which is herein incorporated by reference in its entirety.

### FIELD OF THE INVENTION

The present invention relates generally to weather instruments and methods of using the same, and more specifically to instruments for providing comparisons of current to historical temperatures at the same location.

### BACKGROUND OF THE INVENTION

Global warming is an observed increase in the average temperature of the Earth's atmosphere and oceans and is a great concern for many environmental scientists as well as the public at large. Indeed, global warming is one of the most serious challenges facing the world today.

Current research is attempting to illuminate and quantify the processes and factors that can affect global warming and temperature change more generally. An increasing body of information regarding temperature shifts can help these research attempts and help to further illuminate changes in the Earth's climate systems.

Further, people from all walks of life take an interest in their environment and weather conditions, perhaps because they are gardeners, farmers, bird- or wildlife-watchers, environmental activists, athletes, or business owners whose livelihood depends on the weather.

The present invention provides a weather instrument and method of using the same to generate new and useful information in the study of climate change.

### SUMMARY OF THE INVENTION

The invention in one aspect relates to a weather instrument for comparing current temperature at a location to historical temperatures at the location. In one embodiment, the weather instrument includes a temperature sensor producing a temperature signal; a clock producing a periodic time signal; a processor in communication with the temperature sensor and the clock, the processor producing hourly mean temperature measurements from the temperature sensor in response to the periodic time signal; and a memory in communication with the processor. The memory stores hourly mean temperature measurements and historical temperature data for the location.

In another embodiment, the hourly mean temperatures are site-specific normal temperatures for the location. In yet another embodiment, the weather instrument is used in a rugged terrain and the method further includes a temperature measurement adjustment to account for temperature lapse rates in the rugged terrain.

In still yet another embodiment, the historical temperature data includes hourly mean temperatures simulated from data accrued over at least 50 years. In another embodiment, the hourly mean temperatures are derived using a modified sine function. In yet another embodiment, the weather instrument further includes a display in communication with the processor and the memory. In still yet another embodiment, the display includes information relating to one or more values selected from the group consisting of: the date; the time; the current temperature; the normal temperature for the given date time and location of the installation area of said weather instrument; the departure from said normal temperature; and the cumulative departure from the normal temperature.

Another aspect of the invention relates to a method of comparing local current temperature with historical temperature data. In one embodiment, the method includes the steps of providing a weather instrument, including a temperature sensor producing a temperature signal; a clock producing a periodic time signal; a processor in communication with the temperature sensor and the clock; a memory in communication with the processor; and a display in communication with the processor and the memory, producing hourly mean temperature measurements from the temperature sensor in response to the periodic time signal and storing the hourly mean temperature measurements and historical temperature data for the location in the memory.

In another embodiment, the method further includes the step of deriving the hourly mean temperatures using a modified sine function of data accrued over at least 50 years. In yet another embodiment, the hourly mean temperatures are site-specific normal temperatures for a defined area in which the weather instrument is used. In still yet another embodiment, the method further includes the step of displaying information relating to one or more values selected from the group consisting of: the date; the time; the current temperature; the normal temperature for the given date, time and location of the installation area of said weather instrument; the departure from the normal temperature; and the cumulative departure from the normal temperature.

In another embodiment, the instrument is designed to be installed in a rugged terrain and the method further includes the step of adjusting temperature to account for temperature lapse rates in the rugged terrain. In still yet another embodiment, the method further includes the step of simulating the hourly mean temperatures from data accrued over at least 50 years. In another embodiment, the method further comprises the step of deriving the hourly mean temperatures using a modified sine function.

### BRIEF DESCRIPTION OF THE FIGURES

FIGS. 1A and 1B are block diagrams of embodiments constructed in accordance with the present invention.

FIGS. 2A-2C show simulations derived according to the present invention with observed hourly means at a particular location.

FIGS. 3A-3C show the application of simulated normal hourly temperatures in a weather instrument according to the present invention in December, 2005 (FIG. 3A), January, 2006 (FIG. 3B) and Feb. 1-23, 2006 (FIG. 3C).

FIG. 4 shows cumulative temperature departures from historical values at a particular location from Dec. 1, 2005 to Feb. 23, 2006.

FIG. 5 shows an example of a graph showing hourly temperatures and temperature departures over a previous 24-hour period.

### DETAILED DESCRIPTION

The weather instruments according to the present invention are unique instruments that can display both the current outdoor temperature and the normal (historical average) temperature for the current date, time, and location. The weather instruments according to the present invention also can show the departure of the current temperature from normal, plus the cumulative departure, which provides a continuous update on temperature changes at the location of the instrument.

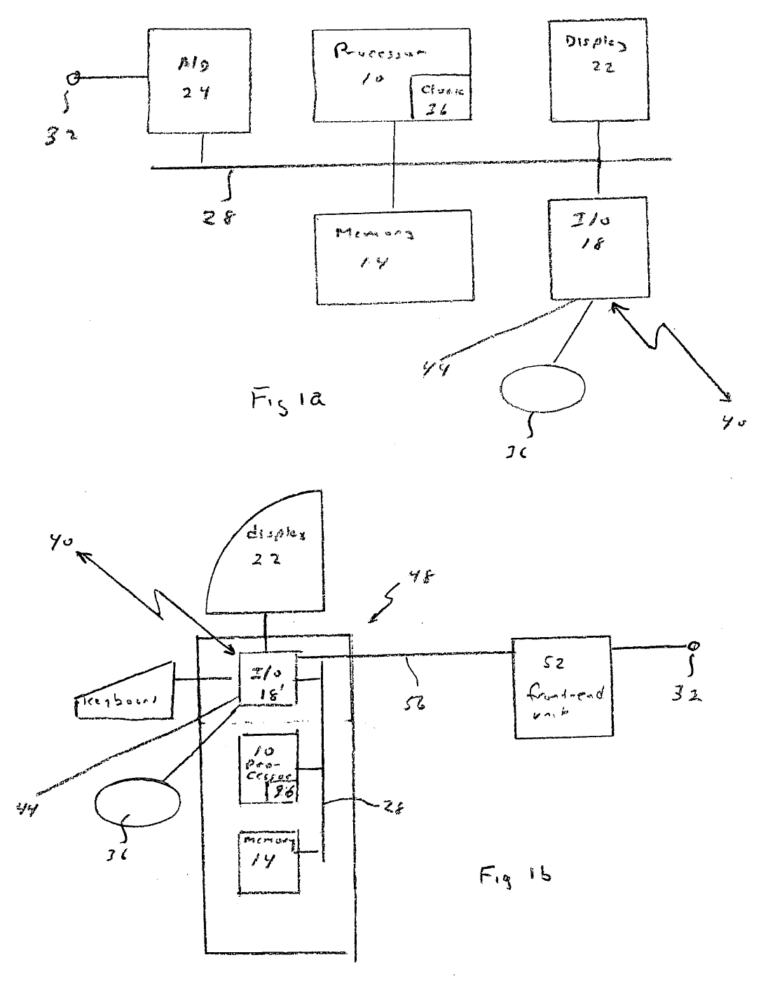

In brief overview and referring to FIG. 1A, an embodiment of the weather instrument constructed in accordance with the invention includes a processor 10, a random access (RAM) and read only (ROM) memory 14, an input/output (I/O) device 18 a display 22 and an analog to digital (A/D) converter 24 all in communication with a bus 28. A thermocouple or equivalent thermal sensor 32 is connected to the A/D converter 24. The processor 10 includes a clock 36. In various embodiments, the processor 10 may be a general purpose microprocessor or a specifically designed circuit. The I/O device in various embodiments may include, but is not limited to, a removable memory 36, a connection to the network 40, or a serial, parallel, or USB port 44. The display 22 in various embodiments may be, but is not limited to, a CRT, LCD, plasma, or multi-segment display. The instrument as described is suitable for a stand-alone unit.

In operation, the processor 10 in the embodiment of FIG. 1A executes software from ROM memory 14. The software causes historical data to be loaded into memory 14 through the I/O device 18 from a specified web site 40, from a disk 36 or from some other storage or transmission device 44, such as a memory stick or modem. Additionally it is contemplated that the historical temperature data for the location in which the instrument is tod be used may be burned in ROM and plugged into the instrument upon distribution to the user. In each case, the individual using the device must provide the longitude and latitude of the observation site of the thermosensor 32 in order to select the correct historical records from the removable medium or the website. In the case of a web connection, all the historical location temperature data may be loaded in a single access of the website, or a single data point corresponding to the local time of day may be accessed from the website each time a new current temperature data point is obtained.

The clock 36 of the processor 10 periodically causes the A/D converter 24 to sample the value on the thermosensor 32 and stores that value in memory 14. The processor 10 then manipulates the present and historical data for presentation on a display 22 in textual or graphic format. It should be noted that although the various components of the device are shown connected to a bus 28 for communication, it is possible to have a single integrated circuit with the processor 10, A/D 24, memory 14 and I/O device 18 functions.

In one embodiment, a display on a weather device according to the present invention looks tabular and may be presented as depicted below.

| | | Current | | Departure | |
|---|---|---|---|---|---|
| | | Temperature | Normal | from Normal | Cumulative |
| Date | Time | (° F.) | (° F.) | (° F.) | Departure |
| MAR 30 06 | 08:00 | 42 | 39.5 | +2.5 | +248.5 |
| | | | | | degree-hours |
| | | | | | since Jan 1 |

These readings provide the information that the current temperature of 42° F. is 2.5° F. above the historical average at the particular time and location where the weather instrument thermosensor is in place, and also provides the sum of all the hourly departures (a total of 248.5 degree-hours in the depicted example) since January 1. In other words, in the depicted embodiment the temperature at the location has been above historical average since the first of the year. Observing the changes in this depicted Cumulative Departure window provides a clear picture of how the climate is changing at a specific location.

In another embodiment shown in FIG. 1B, the display processing and the historical data input are performed by a general purpose computer such as a personal computer or laptop 48. In such a system, the thermosensor 32 may be connected to a front-end unit 52, connected to the personal computer 48 through a communications link 56. The communications link 56 may be a serial, parallel, optical, USB or other two-way link that permits data and commands to be exchanged with the front-end unit 52. The front-end unit 52 in various embodiments includes an A/D converter and/or an amplifier to permit the signals to reach the computer 48. In another embodiment, the front-end 52 is similar to the system shown in FIG. 1A, but without the display. In this embodiment, the front-end 52 performs all the processing and the computer 48 simply displays the data.

In the embodiment shown in FIG. 1B, the computer 48 periodically, in response to clock 36, causes the front-end 52 to collect data from the thermosensor 32 and return the data to the computer 48. In this embodiment, the communications link 56 is a USB link supplying power and signals to an A/D in the front-end 52. In this embodiment the instrument or a portion thereof is a front-end to a computer.

In one embodiment according to the present invention, the outdoor temperature is sensed with a thermocouple, the date and time are recorded, and the average temperature for the current date and time (in one embodiment, to the nearest hour) is retrieved from a table of stored values. The difference between the current temperature and the hourly normal temperature can be calculated and summed each hour. It should be noted that it is possible to further simulate finer resolution in temperature by, for example, extrapolating between the hourly temperatures to obtain minute temperatures.

The weather instrument historical data according to the present invention are site-specific, thus the normal temperatures loaded into each instrument's memory are valid for its defined area. The size of the appropriate area for a particular instrument will vary depending on the topographic relief of the area and other environmental factors. In most situations, all weather instruments within a 5-mile radius typically use the same table of normal temperatures. A city the size of New York therefore uses weather instruments with the same normal temperature table. An adjustment to account for temperature lapse rates is needed in more rugged terrain where there is a large elevation difference between the placement of a particular weather instrument and the area's normal temperature station. Thus it is possible that if the actual instrument location is several hundred meters above the location at which the historical temperature is taken, it may be necessary to apply a temperature correction to adjust the historical temperature for the altitude difference.

Presently, there are at least 100,000 temperature stations worldwide (10,000 in the United States) with long historical records of daily maximum and minimum temperature observations, some starting in the 19th century. While hourly temperature recordings are available at some locations in some instances, these records are typically too sparse to be useful in accordance with the present invention. Thus, one alternative is to derive hourly records from daily maximum and minimum observations, which are accurate and plentiful.

The length of the historical period used to calculate the mean hourly temperatures is an important factor for the presently disclosed weather instrument. Typically, at least 50 years of an unbroken record is the length of observations so that both the extremes of warm and cool periods can be included. For example, an hourly mean temperature derived from temperature records since about 1980 would be less than ideal because the earth's temperatures have been abnormally high for the past two decades, and as a result the departure from the current temperature would be unrealistically small. In addition, such temperature records should be obtained from a wide coverage of temperature observation sites so that an hourly record can be developed for sparsely populated areas in addition to large cities.

In certain embodiments of the presently disclosed weather instruments, the period of record from 1950-2004 (55 years) is used to calculate hourly means. An accommodation is made to update the hourly mean file at, for example and without limitation, about 5-10 year intervals. The length of the interval can depend on how rapidly the earth's temperature increases in the future. At this time, the difference between the 1950-1995 and the 1950-2005 averages is barely perceptible.

In one embodiment, simulation of mean hourly temperatures from the daily maximum and minimum observations can be accomplished using a modified sine function described in more detail herein.

In one embodiment, the conversion of raw temperature observations of daily maximum and minimums to a table of hourly temperature means can be accomplished in one embodiment using programs to perform five functions:
(1) Extract data from EarthInfo datafiles in NCDC format;
(2) Convert the extracted data to USGS format;
(3) Reconstruct missing observations;

Since hardware failures will have occurred in the reading of temperature data at various sites, missing observations will have to be reconstructed. To reconstruct the missing observations at a given location, a nearby site is used to determine the missing values. To do this values from the two sites are compared and the temperature difference, for the same time, between the temperatures at the two sites is determined. To determine the average deviation between the sites mathematical techniques such as regression may be needed. Once the average deviation is known, which may be season dependent, missing values from one site may be estimated by taking the value from the other site and applying the deviation.
(4) form a file of mean daily maximum and minimum for a long historical period; and
(5) generate a file of mean hourly temperatures.

To generate a file of mean hourly temperatures, a simulation of mean hourly temperatures from the daily maximum and minimum observations can be accomplished using a modified sine function:
Y(h)=1−SIN(X)
where X=(t/24)×6.28 in radians; and t=time (hour of day). A plot of Y(h) resembles a temperature trace over a 24-hour period, however, Y(h) is unitless and must be converted to degrees (Fahrenheit or Celsius), corresponding to the observed maximum and minimum for that day.
T(h)=a(Y(h))+b
where a=(Tmax−Tmin)/(Ymax−Ymin), b=Tmin−a(Ymin), T(h)=temperature at hour h, Ymax=Maximum value of Y over 24 hour period and Ymin=Minimum value of Y over 24 hour period.

The model that determines the distribution of hourly temperatures is calibrated by comparing the simulated versus observed hourly temperatures at the location of the thermosensor. One experimental site is Seattle-Tacoma (SeaTac) airport in Seattle, Wash., USA for the 1992-2005 period. For this location, the hourly observation record is only 24 years long versus 55 years for the maximum and minimum temperature record. Three coefficients are optimized using a linear regression to make the best fit between simulated and observed hourly temperatures for the 122,640 pairs (hours) in the regression. Specifically:
ZD=c1(1−SIN(Tz)+(1−c1))
Tyb=6.28(L/c2)
ZDX=(1−SIN(Tyb))c3(ZD)
Tsim=(I−SIN(TY)+ZDX
where, Tsim=hourly temperature; Tz=H/365; TY=H/24; and H=hour.

Therefore, there are 8760 different equations used to simulate the hourly temperature for one year—one for each hour. There are three different sine functions applied for each hourly temperature calculation.

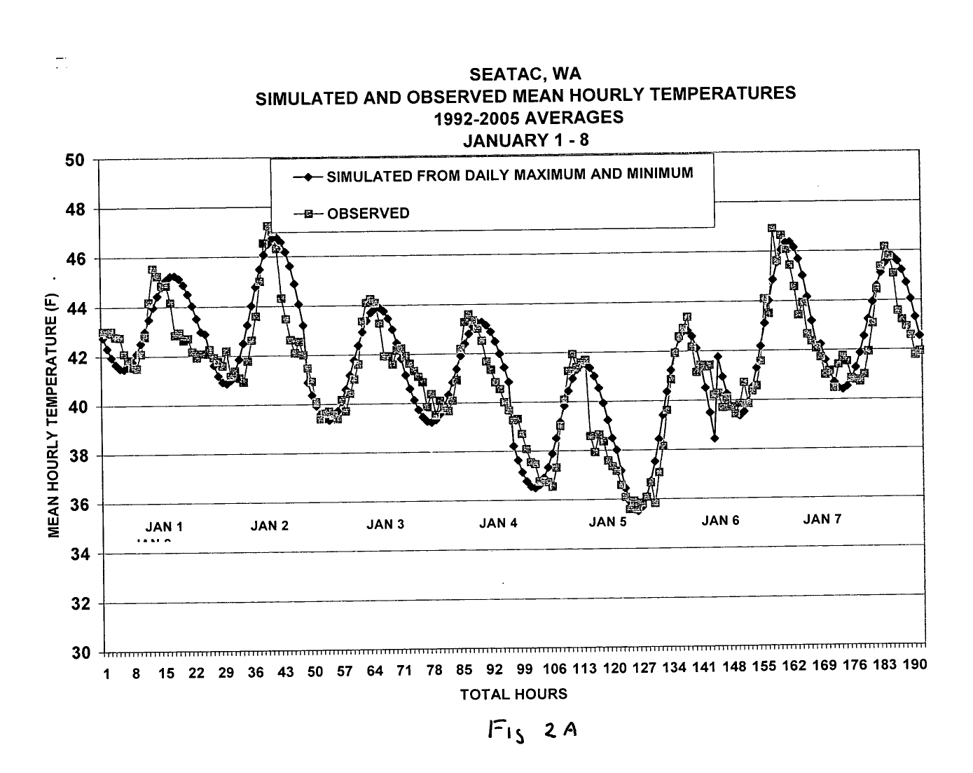

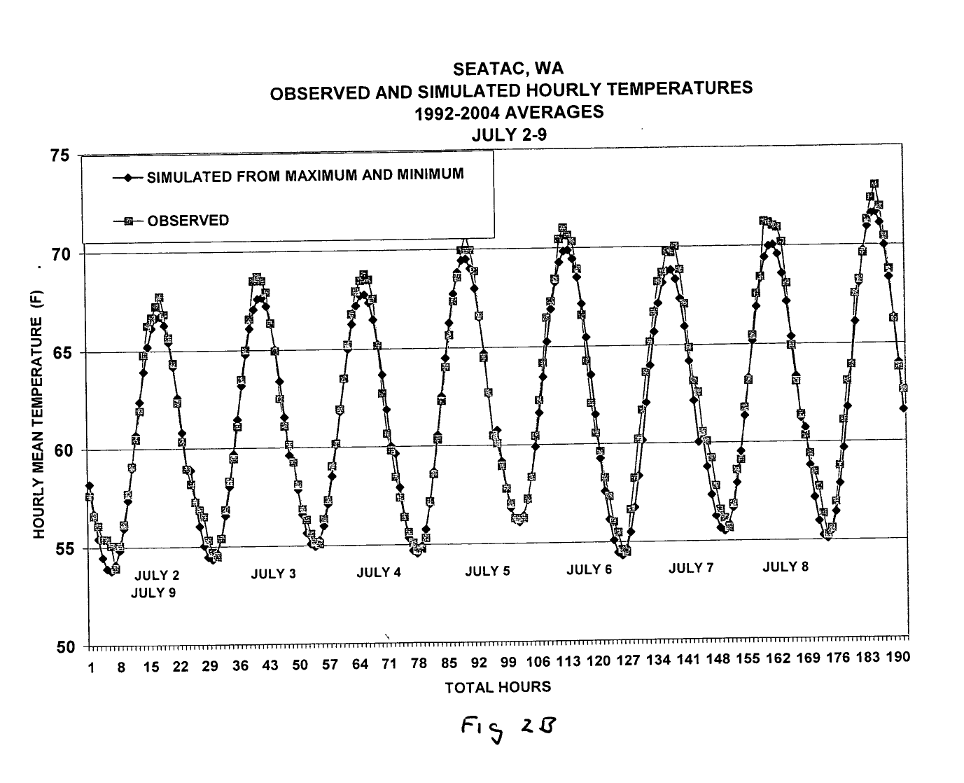

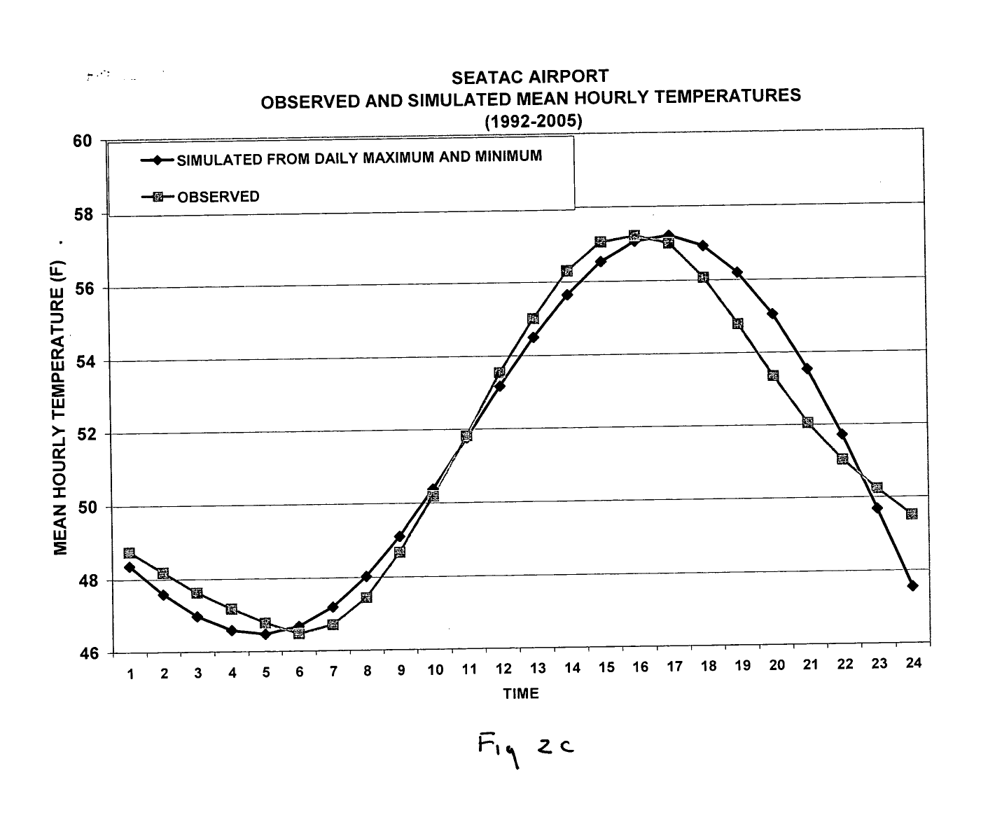

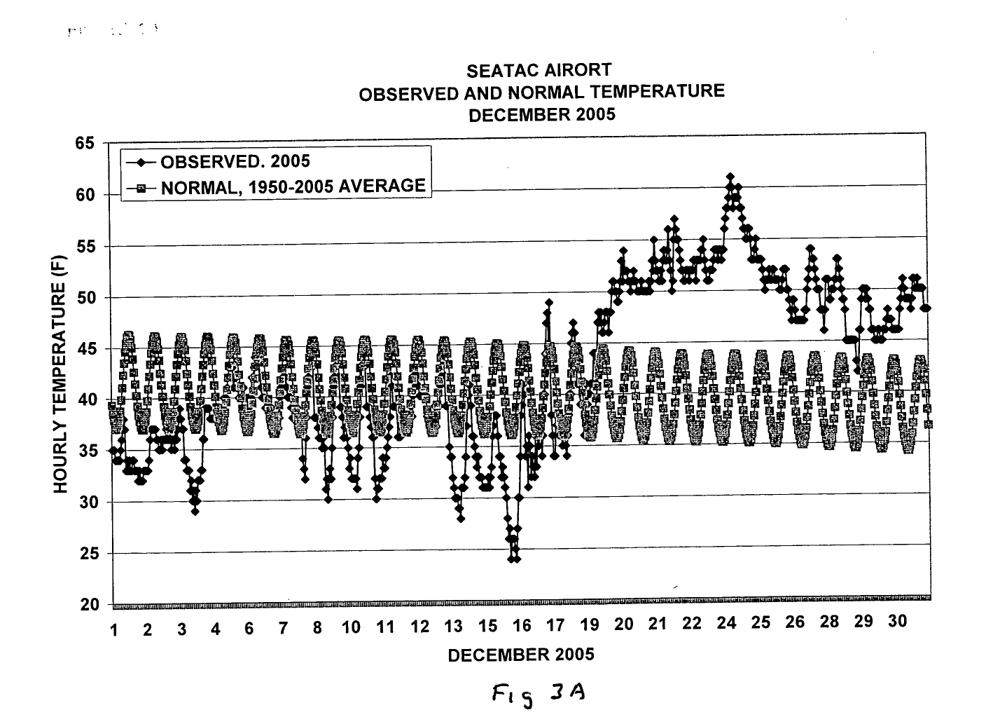

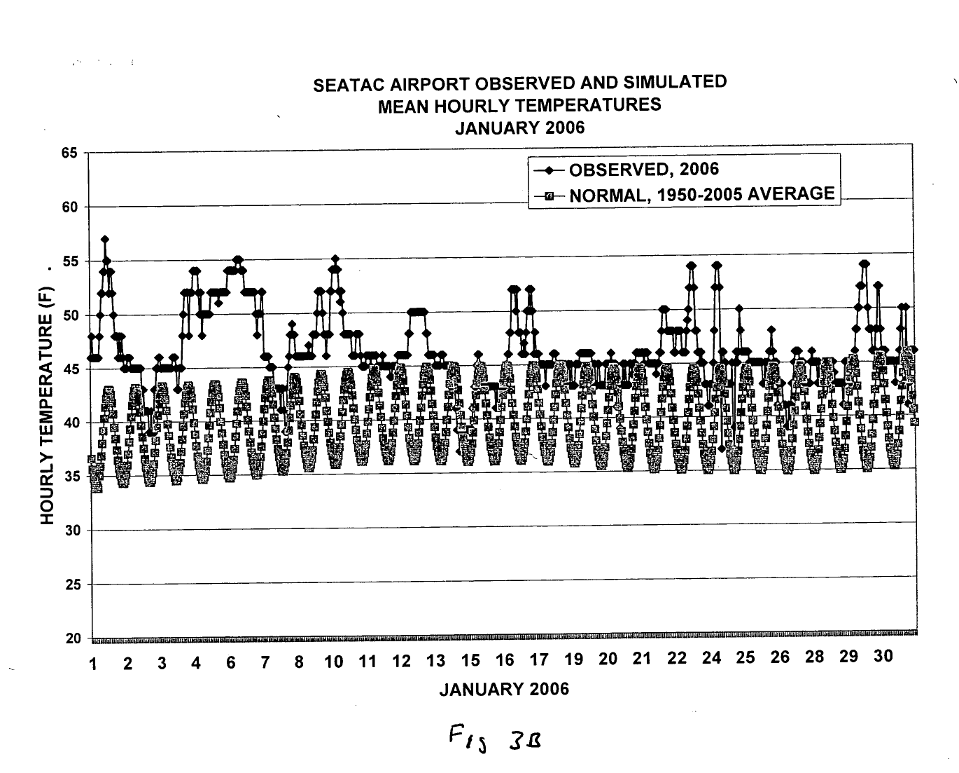

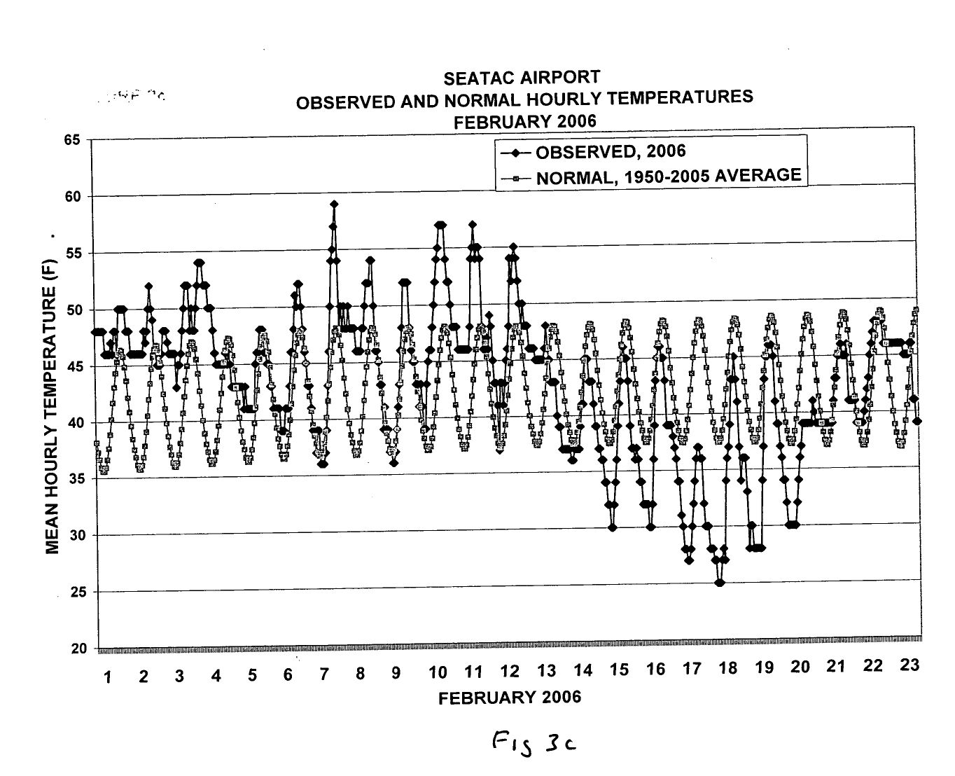

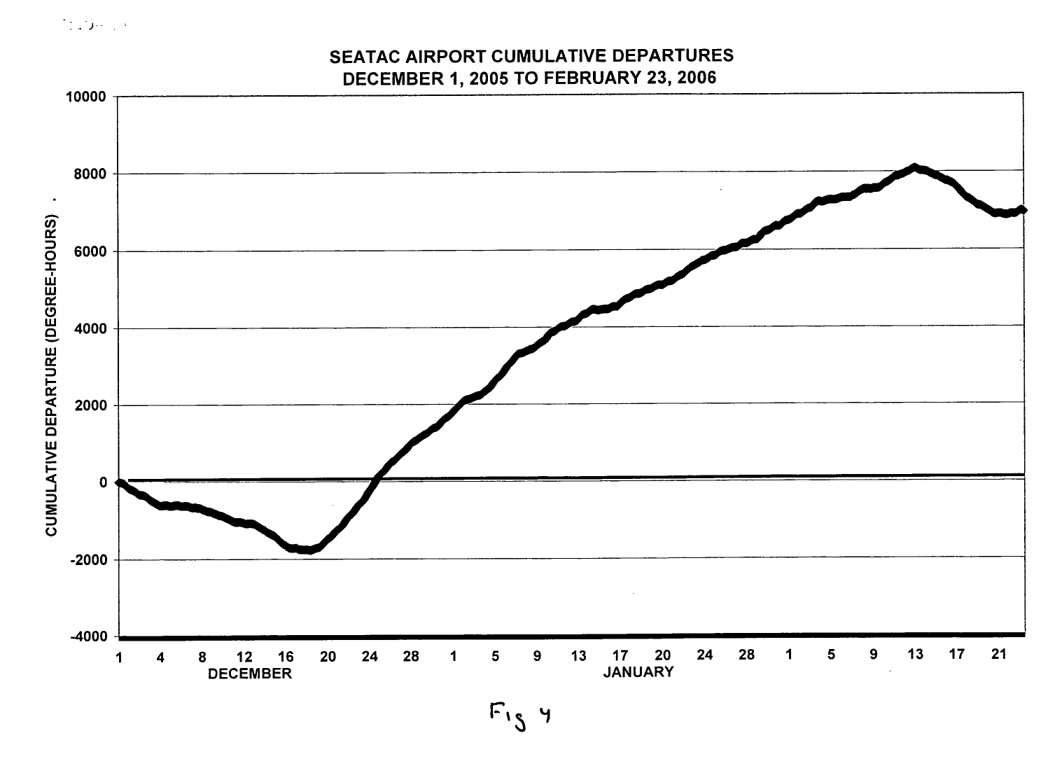

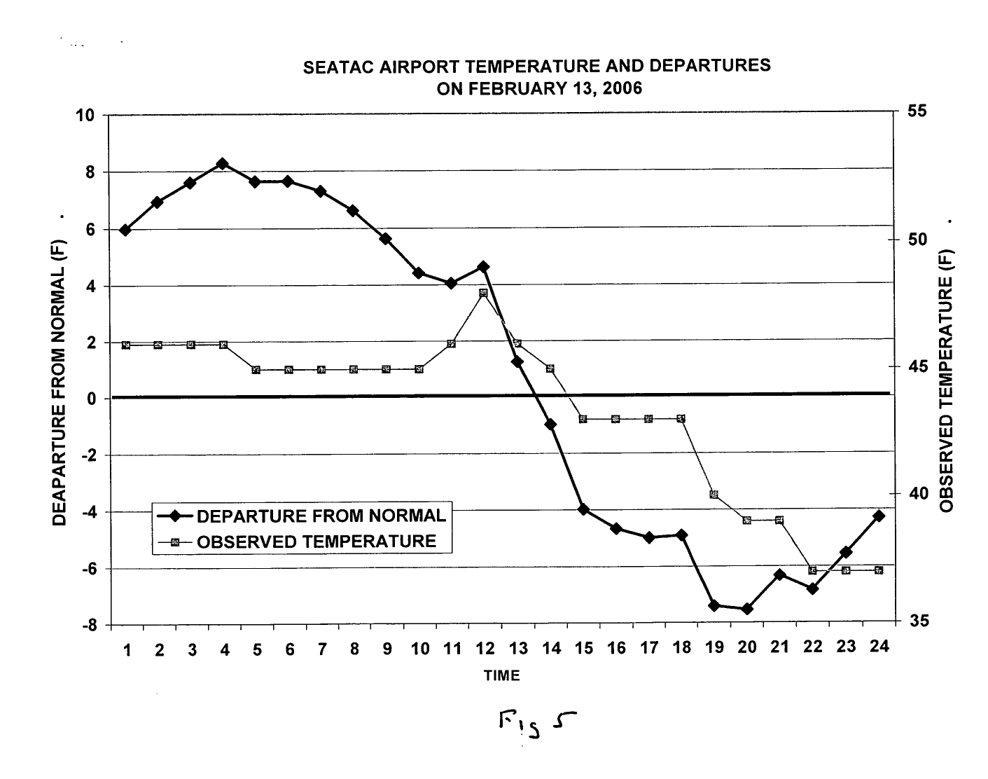

An example of these simulations, compared with the observed hourly mean temperatures at SeaTac airport, is demonstrated in FIGS. 2A-C. Application of the simulated normal hourly temperatures in the weather instrument of the described embodiment is shown in FIGS. 3A (December, 2005), 3B (January, 2006) and 3C (Feb. 1-23, 2006). Cumulative departures from Dec. 1, 2005 to Feb. 23, 2006 are shown in FIG. 4. The weather instrument according to the present invention provides a perspective beyond just knowing the temperature at a single location. By downloading a single file from a weather instrument of the present invention, newspapers, for example, could publish a graph each day showing the hourly temperature and the temperature departures over the previous 24-hour period, such as the example shown in FIG. 5.

As the climate continues to change (and most climatologists agree that it will), there will be even greater interest in the impacts these changes have on humans and their environment. The weather instrument according to the present invention can give people all over the world the opportunity to monitor the changes as they evolve. As examples of uses of the presently described weather instrument, all schools, from primary grades through high school and college, could find this instrument an ideal aid for instructing students about the climate. Atmospheric scientists might use it to prove or disprove current theories about climate change. For example, an array of these instruments installed in close proximity but in variable environments throughout a city could be used to address the existence (or absence of the existence of) the urban heat-island effect.

In closing, it is to be understood that the embodiments of the invention disclosed herein are illustrative of the principles of the present invention. Other modifications that may be employed are within the scope of the invention. Thus, by way of example, but not of limitation, alternative configurations of the present invention may be utilized in accordance with the teachings herein. Accordingly, the present invention is not limited to that precisely as shown and described.

What is claimed is:

1. A weather instrument for comparing current temperature at a location to historical temperatures at the location, said instrument comprising:
a temperature sensor producing a temperature signal;
a clock producing a periodic time signal;
a processor in communication with said temperature sensor and said clock, said processor producing hourly mean temperature measurements from said temperature sensor in response to said periodic time signal, and
a memory in communication with processor,
said memory storing said hourly mean temperature measurements and storing historical temperature data for said location.

2. A weather instrument according to claim 1 wherein said hourly mean temperatures are site-specific normal temperatures for said location.

3. A weather instrument according to claim 2 wherein said weather instrument is used in a rugged terrain and said method further comprises a temperature measurement adjustment to account for temperature lapse rates in said rugged terrain.

4. A weather instrument according to claim 1 wherein said historical temperature data includes hourly mean temperatures simulated from data accrued over at least 50 years.

5. A weather instrument according to claim 1 wherein said hourly mean temperatures are derived using a modified sine function.

6. A weather instrument according to claim 1 wherein said weather instrument further comprises a display in communication with said processor and said memory.

7. A weather instrument according to claim 6 wherein said display includes information relating to one or more values selected from the group consisting of: the date; the time; the current temperature; the normal temperature for the given date, time and location of the installation area of said weather instrument; the departure from said normal temperature; and the cumulative departure from said normal temperature.

8. A weather instrument comprising:
a temperature sensor producing a temperature signal;
a clock producing a periodic time signal;
a processor in communication with said temperature sensor and said clock, said processor producing hourly mean temperature measurements from said temperature sensor in response to said periodic time signal;
a memory in communication with processor; and
a display in communication with said processor and said memory,
said memory storing said hourly mean temperature measurements and storing historical temperature data for said location,
wherein said hourly mean temperatures are derived from a modified sine function using data accrued over at least 50 years; and
wherein said display includes information relating to one or more values selected from the group consisting of: the date; the time; the current temperature; the normal temperature for the given date, time and location of the installation area of said weather instrument; the departure from said normal temperature; and the cumulative departure from said normal temperature.

9. A method of comparing local current temperature with historical temperature data comprising the steps of:
providing weather instrument comprising:
a temperature sensor producing a temperature signal;
a clock producing a periodic time signal;
a processor in communication with said temperature sensor and said clock;
a memory in communication with processor; and
a display in communication with said processor and said memory, producing hourly mean temperature measurements from said temperature sensor in response to said periodic time signal; and
storing said hourly mean temperature measurements and historical temperature data for said location in said memory.

10. The method of claim 9 further comprising the step of deriving said hourly mean temperatures using a modified sine function of data accrued over at least 50 years.

11. The method of claim 9 wherein said hourly mean temperatures are site-specific normal temperatures for a defined area in which said weather instrument is used.

12. The method of claim 9 further comprising the step of displaying information relating to one or more values selected from the group consisting of: the date; the time; the current temperature; the normal temperature for the given date, time and location of the installation area of said weather instrument; the departure from said normal temperature; and the cumulative departure from said normal temperature.

13. A method according to claim 9 wherein said instrument is designed to be installed in a rugged terrain and said method further comprises the step of adjusting temperature to account for temperature lapse rates in said rugged terrain.

14. A method according to claim 9 further comprising the step of simulating said hourly mean temperatures from data accrued over at least 50 years.

15. A method according to claim 9 further comprising the step of deriving said hourly mean temperatures using a modified sine function.
